(19) United States
(12) Patent Application Publication
(10) Pub. No.: US 2007/0110506 A1
(43) Pub. Date: May 17, 2007

(54) Capillary dispenser

(75) Inventors: Gregory Alan Erickson, South Elgin, IL (US); Erik Peterson, Grayslake, IL (US); Wolfgang Witz, Wake Forest, NC (US); Adam J. Hunter, Park Ridge, IL (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/599,227

(22) Filed: Nov. 13, 2006

Related U.S. Application Data
(60) Provisional application No. 60/735,765, filed on Nov. 12, 2005.

(51) Int. Cl. B43K 5/00

(52) U.S. Cl. 401/205

(57) ABSTRACT

Disclosed are fluid dispensers comprising: a) a fluid reservoir, b) a fluid feed line, c) a fluid transfer zone, d) a capillary overflow, e) a capillary control valve, and f) a porous applicator head, wherein: i) the fluid feed line communicates with the fluid reservoir and the fluid transfer zone; ii) the fluid transfer zone is intermediate to the porous applicator head and capillary overflow; iii) the capillary overflow is in communication with the transfer zone and/or the fluid feed line; and iv) fluid is drawn through the porous applicator head by means of capillary action; and v) the capillary control valve regulates the flow of fluid in and out of the capillary overflow.

This application claims the benefit of U.S. Provisional Application No. 60/735,765 filed Nov. 12, 2005.

### FIELD OF THE INVENTION

This invention relates to the application of fluids to a surface by means of capillary action and devices for doing the same. In particular, this invention relates to capillary devices suitable for use in applying liquid cosmetic compositions or liquid personal care compositions to the human body, e.g., the skin.

### BACKGROUND OF THE INVENTION

Devices for applying cosmetic compositions to the body may be broadly divided into two types: contact applicators and non-contact applicators (e.g. spray applicators). The present invention is concerned with the former type of applicator and, in one embodiment of particular interest, to capillary dispensers for liquid cosmetic or personal care compositions.

Capillary dispensers are commonly used in utensils such as writing instruments. U.S. Pat. No. 6,089,776, for example, discloses a fluid dispensing utensil, for example, a writing utensil, comprising: a container defining a fluid storage area for storing fluid, a second storage area and an opening there between; a tip; a capillary conveying line completely filling the opening and extending from the opening through at least a portion of the second storage area to the tip, the capillary conveying line defining a first predetermined average capillarity and a first predetermined uppermost capillarity; and a capillary storage associated with the second storage area, in direct contact with the capillary conveying line, and separated from the first storage area such that the capillary storage only comes into contact with fluid from the first storage area by way of the capillary conveying line, the capillary storage defining a second predetermined average capillarity and a second predetermined uppermost capillarity, the second predetermined average capillarity being substantially less than the first predetermined average capillarity and the second predetermined uppermost capillarity being substantially less than the first predetermined uppermost capillarity. The term “capillarity” is therein used to indicate “the height up to which a liquid ascends within a pore of a given diameter. The greater the height, the greater the capillarity.” The patent characterizes the fluid dispensing utensil therein described as being able to absorb fluid into the capillary storage during periods of container air expansion, with the capillary storage being said to be “substantially emptied” each time the air expansion within the container subsides. At column 3, lines 24 to 26, the capillary conveying line is described as functioning as an air inlet which “eliminates the need to form a very small air inlet in the fluid container.”

Capillary dispensing utensils are also disclosed, for example, in U.S. Pat. No. 6,095,707; U.S. Pat. No. 6,322,268; U.S. Pat. No. 6,413,001; U.S. Pat. No. 6,416,242; and U.S. Pat. No. 6,632,041 which, like U.S. Pat. No. 6,089,776, focus, in particular, on utensils such as writing instruments. In the case of capillary writing instruments, the surface on to which the writing fluid or ink is generally dispensed is a relatively absorbent material such as paper. When applying product by means of a dispenser that relies primarily on capillary action to pull fluid onto the surface to which it is to be applied (i.e., the contact or application surface), the characteristics of that surface may have a significant impact on dispenser operation.

When the contact surface is impermeable to the fluid to be dispensed (i.e., the surface permits little or no absorption of the fluid within the timeframe of fluid application) the amount of fluid deposited from a capillary dispenser may be significantly less than the amount of fluid deposited by the same dispenser on a more absorbent surface. Put another way, an impermeable contact surface may exert little capillary pull to draw fluid from a dispenser in a first pass across the surface, and that pull may be reduced even further once wetted by the first pass. Thus, dispensing from a capillary dispenser onto an impermeable surface (such as, for example, skin) may pose fluid payout issues different from those faced when the dispenser is intended for use on permeable surfaces (such as, for example, paper). The problem of achieving sufficient fluid payout from a capillary dispenser may be exacerbated as the surface area of the applicator head and/or the dosage size is increased.

Achieving sufficient fluid payout may be one factor that has limited the commercial use of capillary dispensers for cosmetic and personal care applications. Additionally, as dispensers are scaled up in size to achieve larger fluid payout, achieving adequate protection against fluid leakage can be increasingly difficult. Moreover, larger dispensers may exacerbate the potential for trapping or stranding fluid in the dispenser.

WO 2004/062423, published Jul. 29, 2004 and claiming a priority date of Jan. 14, 2003, discloses a device for dispensing a liquid cosmetic composition comprising a porous polymeric applicator head, an absorbent material fixed in intimate contact therewith, and a reservoir from which the liquid composition is delivered to the absorbent material, wherein the total capacity of the absorbent material for the liquid cosmetic composition is less than the amount of liquid composition that may be held in the reservoir. This patent application notes that with the use of the absorbent material, there is a certain amount of liquid composition that is retained within the absorbent material as a residue that remains stranded in and cannot be dispensed from the container. To alleviate the problem, the devices therein disclosed additionally comprise a liquid reservoir, the total capacity of which is greater than the total capacity of the absorbent material. The disclosed combination of components is said to enable the reduction of the amount of absorbent material used, thereby reducing the amount of residue retained by the absorbent material.

U.S. Ser. No. 11/026169, filed Dec. 30, 2004, discloses a device for applying a liquid cosmetic composition, the device comprising a porous polymeric applicator head, a porous applicator head, an absorbent material fixed in intimate contact therewith, and a reservoir for the liquid cosmetic composition from which said composition is delivered to the absorbent material which in turn delivers the liquid cosmetic composition to the porous applicator head, wherein the liquid cosmetic composition has a flow rate outward from the porous applicator head of about 0.05 to about 1.0 cc/s when a pressure gradient of 0.5 psi is applied across the applicator head.

One object of this invention is to provide a capillary dispenser that affords desirable leak resistance over the life of the dispenser pack. In at least one embodiment, another object of this invention is to provide a capillary dispenser that minimizes the amount of fluid that remains stranded in the dispenser at the end of the dispenser pack life. In at least one embodiment, yet another object of this invention is to provide a capillary dispenser capable of providing desirable fluid payout over a relatively large contact surface. In at least one embodiment, yet another object of this invention is to provide a capillary dispenser capable of providing desirable fluid payout to an impermeable contact surface, e.g., skin.

### SUMMARY OF THE INVENTION

It has now been found that by equipping a capillary dispenser comprising a reservoir, a fluid feed line, and an applicator head, with (a) a fluid transfer zone in communication with the fluid feed line and the back of the applicator head, (b) a capillary overflow that communicates with the fluid feed line and/or the fluid transfer zone, and (c) a capillary control valve that regulates the passage of fluid and air in and out of the capillary overflow, there is provided a dispenser having good protection against fluid leakage over the dispenser pack life. Moreover, it has been found that such dispensers can be scaled in size to deliver desirable fluid payouts over relatively large contact surfaces, e.g., from 10 to 30 cm², or greater, as well as over smaller contact surfaces. Additionally, the subject dispensers has been found to be particularly well suited to delivering fluid onto impermeable surfaces including, but not limited to, skin.

Accordingly, in one embodiment of this invention there is provided a fluid dispenser comprising:

a) a fluid reservoir,

b) a fluid feed line,

c) a fluid transfer zone,

d) a capillary overflow,

e) a capillary control valve, and

f) a porous applicator head, wherein:

i) the fluid feed line communicates with the fluid reservoir and the fluid transfer zone;

ii) the fluid transfer zone is intermediate to the porous applicator head and capillary overflow;

iii) the capillary overflow is in communication with the transfer zone and/or the fluid feed line;

iv) fluid is drawn through the porous applicator head by means of capillary action; and

v) the capillary control valve regulates the flow of fluid in and out of the capillary overflow. Desirably, the capillary overflow is in communication, preferably direct communication, with the transfer zone via the control valve.

In a further embodiment there is provided a method of dispensing a fluid onto a surface which comprises bringing the applicator head of the dispenser of this invention into contact with, and moving it across such surface.

### DESCRIPTION OF THE DRAWINGS

FIG. 1 is a vertical cross section of one embodiment of a dispenser in accordance with this invention, in an upright orientation.

FIG. 2 is a perspective view showing one embodiment of transfer zone, fluid feed line, and gross capillary components in accordance with this invention.

### DETAILED DESCRIPTION OF THE INVENTION

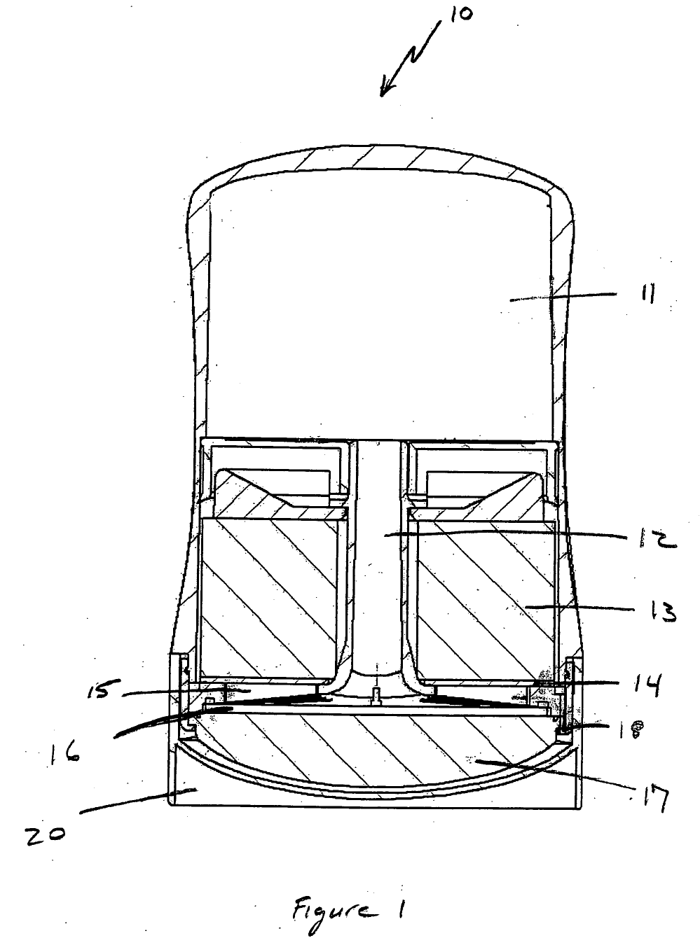

Throughout this specification, the terms “upper” and “lower” are used in relation to an orientation of the dispenser with the applicator head at its top and the reservoir at its bottom. The applicator head up/reservoir down orientation is also interchangeably referred to as the “upright”, “applicator head up” or “head up” orientation or position. In at least one embodiment, e.g., deodorant or antiperspirant dispensers, it is contemplated that dispensing of fluid may take place with the dispenser in an applicator head up orientation, however, in moving the applicator head across the underarm region, it should be recognized that the angle at which the applicator head makes contact with the skin may be widely variable. In at least one embodiment, it is contemplated that the dispenser may be stored in an “applicator head down” orientation, as shown in FIG. 1. In the context of this invention, unless otherwise indicated, throughout the subject specification and claims, reference to “fluid” means fluid in the form of a liquid.

The fluid capacity of the dispenser (i.e., the amount of fluid contained by the dispenser prior to the initial dispensing, also referred to as the “total fluid capacity”) is widely variable. The fluid capacity will normally be dictated by the amount of fluid the intended user can comfortably hold, preferably in a single hand, as well as the fluid dose required for the intended application. In many applications the fluid capacity of the dispenser is from 5 ml to 200 ml, more particularly from 10 ml to 150 ml, and, in at least one embodiment of particular interest, from 20 ml to 100 ml. For personal care applications, deodorants and antiperspirants in particular, dispensers having fluid capacities of from 30 to 70 ml are, in at least one embodiment, of particular interest. Greater or lesser fluid capacities may be of interest, depending upon the particular application.

Preferably, the reservoir and the fluid feed line are in intimate contact, however, one or more intervening components may be present, e.g., additional fluid containment or conduit elements, provided, that free fluid communication between the reservoir and fluid feed line is maintained. The feed line is preferably a hollow tubular structure having one or more ends terminating at the fluid reservoir and one or more ends terminating at the fluid transfer zone. Preferably the cross-sectional geometry of the feed line is round, e.g., circular, however, myriad geometries are possible. One or more fluid feed lines may be present in the dispensers of this invention.

The reservoir provides a contained space for holding the fluid to be dispensed and defines a volume that is taken up by (a) the fluid to be dispensed and (b) a headspace. In the priming process, i.e., the initial loading of the applicator head, the applicator is placed in the head down/reservoir up position such that gravitational force causes fluid to flow from the reservoir, through the fluid feed line and into the transfer zone. The combination of gravitational force and capillary action draws fluid from the transfer zone into the applicator head.

When the dispenser is oriented in the head down/reservoir up position, the distance from the back surface of the applicator head (i.e., the surface of the head in contact with the transfer zone) to the uppermost level of fluid in either the reservoir or, when the such level drops below the reservoir, the fluid feed line, defines a fluid column height C. In the practice of this invention, the contents of the dispenser are maintained under a negative pressure such that the reservoir headspace is capable of supporting the fluid column when the applicator head is in an orientation beneath the reservoir, i.e., the reservoir headspace has a vacuum pressure (in mm water), the absolute value of which is greater than the column height C.

The negative pressure in the dispenser helps to minimize or reduce leakage through the applicator head, however, if the negative pressure in the dispenser is too high, it may deleteriously impact fluid payout. Under what are herein termed “standard conditions” (i.e., an external environment of 1 atmosphere of pressure and a temperature of 25° C.), the negative pressure in the container is desirably engineered to range from about 25 mm (water) to about 250 mm (water), more particularly from 75 mm (water) to 200 mm (water), as determined by measuring the headspace PSI. Greater or lesser pressures may be of interest, depending upon container design, as well as the volume of the reservoir and fluid to be dispensed.

In response to changes in environmental temperature or pressure, the headspace volume will either expand or contract. As headspace volume expands, fluid is forced out of the reservoir, the column height C decreases, and the pressure in the system becomes more positive. To compensate for the effect of headspace expansion, the system is sized to minimize the initial headspace volume, i.e., the headspace volume after priming and prior to the first dispensing of fluid. In one embodiment, the initial headspace volume comprises from 5 to 50%, more particularly, from 5 to 35% of the total reservoir volume. Initial headspace volumes of from 20 to 35% of the total reservoir volume are, in at least one embodiment of this invention, of particular interest.

When headspace volume expands rapidly (such as may take place in dispensers taken aboard aircraft when the aircraft climbs to its cruising altitude), the flow of fluid into the overflow must be sufficiently great that leakage out of the applicator head is prevented or minimized. Thus, the advancing capillary of the overflow needs to be sufficiently high that fluid flows into the overflow, rather than out of the of the applicator head. Conversely, when the headspace volume in the fluid reservoir contracts, (such as may take place during aircraft landing), the receding capillary out of the overflow must be of sufficiently low to unload the overflow and minimize fluid stranding. Changes in environmental temperature will also impact flow in and out of the overflow, particularly when large volumes of volatile solvent are present.

The capillary overflow is preferably a porous material capable of absorbing and releasing fluid. Desirably, the overflow comprises a material that, in use, has an “open volume”, i.e., the percentage of the material volume that can be occupied by fluid, of greater than 60%, more particularly from 70 to 95%, and in at least one embodiment, from 75-90%. In general, the lower the percentage of material volume that can be occupied by fluid, the greater size of the overflow from it is fabricated.

While maximization of open volume is desirable, the overflow material should also provide sufficient advancing capillary pressure to prevent leakage, i.e., if the advancing capillary is too low, the ability of the overflow to take up fluid in response to rapid headspace expansion may be impaired. While a higher advancing capillary pressure may be desirable as regards the take-up of fluid into the overflow, if it is too high, it may inhibit fluid release.

Pore size, size distribution, and material density are among the factors that affect the operation of capillary overflow and its rate of fluid take-up. Owing to the distribution therein of pores of different size, porous materials generally take-up and release fluid over a variety of pressures.

In one embodiment of this invention it is desirable that the capillary overflow provides an advancing capillary pressure of from about 15 mm (water) to 300 mm (water), preferably from about 15 mm (water) to 250 mm (water). Advancing capillaries of from about 25 mm (water) to 100 mm (water) are of interest in at least one preferred embodiment.

Exemplary, but not exhaustive, of the porous material from which the overflow may be fabricated are foams and sponges, as well as fiber mats, pads, battings or masses, with materials known in the art as bonded fiber capillary products, being of particular interest. Any of a variety of synthetic polymers may be suitable for the fabrication of such materials. Polyolefins, polyesters, and nylons are representative, but not exhaustive of the polymeric materials from which the porous material comprising the capillary overflow may be fabricated. Of particular interest in the practice of this invention are bonded fiber capillary products, preferably products having a gram for gram holding capacity (i.e., the maximum amount of fluid, in grams, that can be held by one gram of absorbent material at 1 atmosphere of pressure and 25° C.) of from 4-8 g/g, preferably about 6 to 7 g/g.

If the overflow is too large, the potential to strand fluid in the reservoir increases. Conversely, if the overflow is too small, leak protection may be compromised. Desirably, the overflow is sized to accommodate the maximum amount of fluid that is calculated to be captured by the overflow in response to the greatest pressure differential that the pack is designed to survive. For many applications it is desirable to size the overflow to accommodate up to 60% of the fluid capacity of the dispenser. With overflows capable of accommodating up to 50% and, more particularly, up to 40% of the fluid capacity of the dispenser being of particular interest.

The capillary control valve controls the flow of fluid in and out of the overflow in response to changes in the system pressure. It communicates with the capillary overflow and the fluid transfer zone and/or fluid feed line. In at least one preferred embodiment, the capillary overflow communicates with the fluid transfer zone. The capillary control valve also functions to control the operating pressure of the system by allowing gas to entering the system through the transfer zone to travel through the feed line and up to the head space.

Desirably, the control valve comprises a capillary material and, more particularly, a capillary material having low impedance to the flow of fluid (i.e., fluid flows relatively freely through the capillary material) and a relatively high impedance to air. In one embodiment of interest, the control valve comprises a plurality of capillary pores in the fluid feed line which are of sufficient size and number to enable liquid flow and to regulate the operating pressure of the dispenser; preferably such voids taper in the direction of the capillary overflow. In another embodiment of interest, the capillary material comprises a material having a 3-dimensional porous network structure, i.e., within the material, pores are found at multiple depths; such a distribution of pores aids in retaining fluid in the capillary control valve and keeping it wet over the life of the pack, thereby maintaining operating PSI. In use, compression of the 3-dimensional porous network structure against the components with which it is in intimate contact may improve its communication with those components.

Suitable capillary materials from which the capillary control valve may be fabricated include foams and sponges, fiber pads, mats batting and masses, as well as bonded fiber capillary products. Such capillary materials may be fabricated from a variety of synthetic polymers, including the polymers mentioned above in the description of the capillary overflow.

Desirably, the fluid control valve is positioned as close as possible to the fluid transfer zone. It has been found that by placing the capillary valve in a position that maintains fluid contact with the transfer zone, maximizes leakage protection at the end of the dispenser life. Alternatively, it is possible to position is the fluid control valve at a position further away from the fluid transfer zone, closer to the reservoir. However, in this alternative configuration, as the height of the fluid in the fluid feed line falls below the position of the control valve, the capillary connection with the overflow is lost, potentially allowing some material to leak out of the dispenser.

Desirably, the capillary control valve communicates with the fluid transfer zone and/or fluid feed line through one or, more preferably, a plurality of transfer ports. The transfer ports are sized to allow for the free flow of fluid and air through same. The ports are preferably configured as a plurality of slots or holes that allow for fluid/air passage. In addition to providing for the passage of fluid through the capillary control valve, and in and out of the fluid transfer zone and/or fluid feed line, the transfer ports allow air bubbles drawn into system to ascend through the fluid feed line into the head space of the fluid reservoir. When equipped with such transfer ports, the fluid transfer zone preferably inclines toward the fluid feed line so as to aid in bubble ascent. Alternatively, when the capillary control valve communicates with the fluid feed line, the transfer ports may be located on the fluid feed line itself.

The fluid transfer zone comprises a fluid containment area that communicates with the fluid feed line and the lower surface, i.e., back, of the applicator head. Optionally, the fluid transfer zone further comprises a gross capillary in direct or indirect contact with the applicator. The gross capillary is configured to hold fluid at the back of the applicator head, and aids in the delivery of fluid thereto. It may, for example, take the form of a plurality of capillary silts or voids, however, numerous alternative forms, e.g., grids, grates, plates, and the like, are possible. The presence of this gross capillary is particularly desirable when the applicator head comprises a non-compressible material, and aids in indexing the flow of fluid into the applicator head in the head up orientation.

The applicator, alternatively referred to as the “head” or “applicator head” is the terminal portion of the dispenser that makes contact with the surface to which fluid is to be dispensed. The applicator may itself be comprised of one or more components. The applicator head provides capillary contact with the surface to which the fluid is to be dispensed.

Desirably, the applicator head is sized to accommodate the volume or dosage of fluid to be dispensed. In one embodiment of interest the outer surface of the applicator head has an area of from 1-100 cm², more particularly from about 1-50 cm². In at least one embodiment of interest the dispenser has a surface area of from 5-30 cm², more particularly from 10-30 cm². In another embodiment of particular interest the applicator head has a surface area of from 5 to 20 cm². It should be recognized that larger or smaller dispenser heads may be interest depending upon the particular application.

The applicator head preferably comprises a porous material. The porous material may be deformable or non-deformable. As with the other capillary components of the subject invention, the pore size, pore size distribution, and pore density are factors that need to be taken out in designing a suitable applicator head. Desirably, the capillary pull of the applicator head is such that it absorbs, conducts and releases fluid.

Suitable materials from which the head may be fabricated include, for example, synthetic resins which are processed, such as for example, by sintering, to provide omni-directional interconnecting pores. Such resins include, for example, nylon, high-density polyethylene, low-density polyethylene, ultra-high molecular weight polyethylene, polypropylene, or polyvinylidene fluoride, polyacetal and the like. In other and, in some instances, more desirable embodiments, the applicator comprises a deformable absorbent material in combination with a woven or non-woven fabric or mesh. Like the non-deformable porous plastic, the deformable absorbent material transfers fluid by capillary flow or wicking. Unlike the non-deformable applicator, the deformable applicator allows users to adjust fluid pay-out by applying greater or lesser amounts of pressure. The absorbent material may take the form of a self-supporting or non-self-supporting structure. The self-supporting absorbent material may itself be a mono- or multi-component structure, so as to provide the desired combination of rigidity and absorbency. The term “non-self-supporting structure” refers to an absorbent material whose shape is retained and or defined by a secondary means.

The deformable absorbent material may be any material that is capable of absorbing the fluid to be applied and conducting it through to the outer surface of the applicator. Foams, sponges, fibrous materials in the form of pads, batting, felts, and the like, and non-wovens are among the deformable absorbent materials that may be used in the practice of this invention.

When a non-self-supporting structure is employed, it may be desirable for the applicator to further comprise a support means that assists in defining and retaining the shape of the applicator. Exemplary, but not exhaustive, of such support means are cage and ribbed structures, as well as a non-porous dome. The support means should not be so large as to impede or otherwise interfere with the capillary action of the dispenser.

Desirably, the outer surface of the deformable absorbent material is covered with a fabric, mesh or sheet that is selected to provide a desired sensory or visual element. Microfiber materials with a sueded hand or feel can, for example, provide a pleasant tactile sensation. Moreover, the fabric, mesh or sheet can provide an element of color or design heretofore lacking in applicator heads commonly used in cosmetic applications. If desired, a similar material may also be used over a non-deformable porous plastic.

The dispenser is equipped with a containing—or side-wall that defines its periphery. The sidewall may form a portion of the fluid reservoir with the uppermost boundary of the reservoir commonly being a separating wall or divider that extends across the horizontal cross section of the dispenser. The feed line passes through this separating wall or divider in order to bring the fluid in communication with the fluid transfer zone. Additionally, the periphery defined by the containing wall together with the uppermost boundary of the reservoir will in at least one embodiment of this invention, surround the bottom, and side surfaces of the overflow. To minimize evaporative loss, the top surface of the overflow is normally bounded by the bottom surface of the transfer zone, which together with the periphery defined by the containing walls seals and forms an uppermost boundary to the overflow-containing section of the dispenser.

The containing walls and separating walls may be made from a material impervious to the fluid to be dispensed. Typical materials are plastics, such as polyolefins like polypropylene or polyethylene: polyesters such as poly(ethylene terephthalate) (PET), poly(butylene terephthalate) (PBT); acetal; and the like, with such materials being merely exemplary, but not exhaustive of the plastics suitable for use herein. Materials of preference depend on the product being dispensed and the solvents present therein. In one embodiment it is desirable that the material is rigid, and resists deformation in use.

Optionally, a collar or other retaining means may be used to affix the applicator head to the fluid transfer zone and body of the dispenser.

A cap for covering the applicator head is a desired additional feature of the device. Such a cap can prevent accidental contact with the applicator head and reduce the loss of any volatile components from the composition within the pores of the applicator head. The cap preferably contacts the sidewall around the applicator head. The cap may be hinged onto the sidewall or may be fully removable. A fully removable cap may be held onto said sidewall by a screw-thread or a simply by friction between the inner surface of a sidewall of the cap and the outer surface of the absorbent material or a sidewall around. Preferably, the cap connects to the dispenser by means of a snap fit.

Desirably, the cap provides secondary leak protection to the dispenser when the fluid to be dispensed loses contact with the capillary control valve. Desirably this is accomplished by creating a capillary gap between the outer surface of the applicator head and the cap. The dimension of this space is subject to variation, but in at least one embodiment is up 6 mm, more particularly, up to 3 mm. If the gap is too large, capillary contact with the applicator head may be lost.

A vent from the overflow chamber giving access to the atmosphere is a preferred feature of dispensers described in the present invention. Preferably the vent is positioned beneath the dispenser cap so as to inhibit evaporative loss. It may be desirable, particularly when venting to a position other than under the cap, to equip the vent with a means of impeding evaporative loss, for example, a trap or a tortuous path to increase vent path internal surface area. Other means to inhibit loss include the use of valves that open in response to a designated pressure differential being reached. Such valves include, for example, duckbill, slit and umbrella valves. Desirably the vent is positioned so that it does not come into fluid communication with the liquid in the dispenser.

The position of the vent and the strength of the seal of the cap to the dispenser are factors that can influence the size of the overflow. For example if the overflow is vented to a position under the cap and there is both a high strength, robust connection of the cap to the dispenser and the seal of the cap to the dispenser is such that evaporative loss is inhibited (i.e., a “near hermetic seal”) then, in overpressure situations, pressure build-up can take place under the cap at a rate that tends to approximate the rate of pressure build-up in both the overflow area and reservoir. This “equilization” of pressure build-up rate, effectively reduces the volume of liquid flowing into the overflow, allowing the capacity of the overflow, as reflected in its size, to be reduced.

While a smaller overflow may be desirable in terms of reducing raw material costs and increasing pack efficiency, the strength of the cap seal needs to be balanced against the ease of cap removal. When venting under the cap, to accommodate overpressure situations, it may desirable to provide the cap with a means of off-gassing to the atmosphere when a desired internal pressure is reached, such as, for example, a pressure sensitive valve.

In a preferred the fluid dispenser comprises:

a) a fluid reservoir,

b) a fluid feed line,

c) a fluid transfer zone,

d) a capillary overflow,

e) a capillary control valve that regulates the flow of fluid in and out of the capillary overflow, and

f) a porous applicator head, preferably comprising a deformable absorbent material having a fabric, mesh, sheet or sensory material covering or overlay, the absorbent material preferably having an open volume of greater than 60%. wherein:

i) the fluid feed line communicates with the fluid reservoir and the fluid transfer zone;

ii) the fluid transfer zone is intermediate to the porous applicator head and capillary overflow;

iii) the capillary overflow is in communication with the transfer zone via the capillary control valve; and

iv) fluid is drawn through the porous applicator head by means of capillary action.

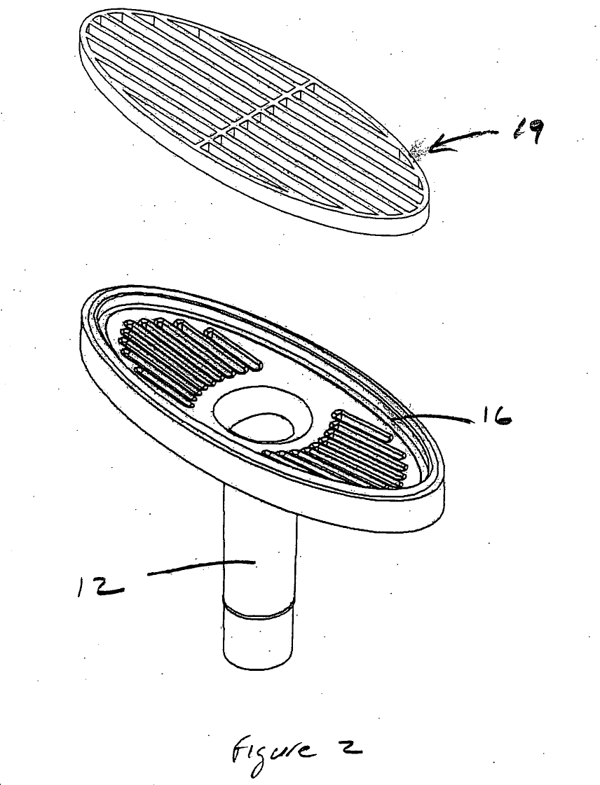

FIG. 1 is a non-limiting example of an embodiment of a dispenser in accordance the subject application. The dispenser illustrated in FIG. 1 (generally represented by a reference numeral 10), includes a fluid reservoir 11, a fluid feed line 12, a capillary overflow 13, a capillary control valve 14, a transfer port 15, a fluid transfer zone 16, an applicator head 17, and a vent 18. The applicator head is shown covered with a cap 10. FIG. 2 is a non-limiting perspective view, showing fluid transfer zone 16, in communication with fluid feed line 12; with a gross capillary 19, shown as a separate element.

The dosage to be dispensed will vary depending upon the intended application. While it is contemplated that that the dispensers may be used with a variety of topically applied cosmetic products and personal care products, including, for example, perfumes, deodorants and antiperspirants. The dispensers may also be used to dispense other fluids to the skin surface including, for example, antiseptics, and medicaments. Additionally, it is contemplated that the dispenser may be used to dispense stain removers, cleaners and various other home care products. Desirably, the product to be dispensed should maintain a desirable dispensing viscosity throughout its shelf life. Additionally, the product should be able to spread easily through the porous components of the dispenser.

In at least one embodiment, the products to be dispensed will have room temperature viscosities less than 100 centipoise (cps), preferably from 1 to 50 cps, with viscosities of from 5 to 30 cps as well as viscosities of from 8 to 15 cps being of particular interest. Additionally, the products will have surface tensions that allow them to readily spread through and wet the porous components of the applicator. The degree to which the products will spread depends in large part on the nature and amount of solvent and, if present, surfactant present therein. In one embodiment, the products to be dispensed have surface tensions of from 20 to 50 dynes/cm, more particularly from 20 to 35 dynes/cm. Among the products suitable for herein are the compositions described in U.S. application Ser. No. 10/748,945, filed Dec. 29, 2003, incorporated herein by reference.

The products to be dispensed may comprise a variety of different forms, including, but not limited to aqueous and non-aqueous solutions, co-solvent systems, mixed solvent systems, and colloidal dispersions such as, for example, microemulsions, liposomal dispersions, liquid crystal dispersions, and emulsions (oil-in-water and water-in-oil) In many applications, anhydrous solutions, cosolvent systems, mixed solvent systems, and emulsions (including microemulsions and phase inversion temperature emulsions) are of particular interest.

In one embodiment, it is highly preferred that the fluid does not comprise solid particulates. Such particulates can lead to blockage of the pores in the applicator head and/or detract from the sensory performance of the product.

However, if the solid particulates are smaller than the pore size of the smallest capillary component, and are well suspended in the carrier medium, solid particulates may be present.

While many of the compositions that follow are described with reference to antiperspirants, the description regarding the product forms of these compositions has application to formulations other than antiperspirants. Allowing for formulation changes brought about by the removal, substitution and/or supplementation of the antiperspirant active, the product forms may be adapted to other cosmetic and non-cosmetic products.

Except in the formulations provided in following tables, or where otherwise explicitly indicated, all numbers in the specification and claims indicating amounts of material or conditions of reaction, physical properties of materials and/or use are to be understood as modified by the word “about”. All amounts provided with respect to product compositions are by weight of the final composition, unless otherwise specified.

In the case of antiperspirants, desired properties include: antiperspirant efficacy, smooth and cool touch application, quick drying, low stickiness, clear application, and stability. Compared to the formulations used in conventional liquid antiperspirant forms such as, for example, roll-ons, the subject antiperspirant formulations are generally less viscous and less sticky products. The subject compositions may be formulated to provide a desirable combination of sensory properties for their intended application. Characteristic of many of the subject antiperspirant compositions is the presence of one or more antiperspirant actives; one or more cosmetically acceptable volatile organic solvents; one or more cosmetic oils; optionally, surfactant, which depending upon the product form may emulsify fragrance and/or cosmetic oils, aid in preventing phase separation, promote stability, and/or allow for greater amounts of cosmetic oils to be incorporated; optionally, water; optionally, fragrance oils; and, optionally, one or more additional ingredients including, for example, skin benefit agents, antimicrobials, efficacy assistants, preservatives, antioxidants, fragrance fixatives, and viscosity modifiers.

Exemplary of the antiperspirant actives that may be employed in the subject antiperspirant compositions are one or more aluminum, zirconium and/or mixed aluminum/zirconium salts, optionally complexed. Preferred aluminum, zirconium and aluminum/zirconium salts contain a halide, especially chloride and especially preferred salts are basic salts, which is to say a fraction of the halide within the empirical formula has been replaced by bound hydroxyl groups. In at least one embodiment, halohydroates, particularly chlorohydrate salts are particularly desired. The salts may have coordinated and/or bound water in various quantities and/or may be present as polymeric species, mixtures or complexes.

In at least one embodiment, aluminum chlorohydrate, aluminum chloride, aluminum zirconium tetrachlorohydrex glycine, and aluminum zirconium pentachlorohydrate are among the antiperspirant actives that are of particular interest in the practice of this invention, with the active of preference depending, in part, on the form of the antiperspirant formulation.

Aluminum halohydrates include, but are not limited to, salts defined by the general formula Al₂(OH)ₓQ_{y}.wH₂0 in which Q represents chlorine, bromine or iodine, x is variable from 2 to 5 and x+y=6 while wH₂O represents a variable amount of hydration. Aluminum chlorohydrate as made comprises a mixture of a number of different polymeric species in varying proportions, depending on the molar ratio of aluminum to chloride and the conditions employed during manufacture. All such mixtures are employable herein.

Zirconium actives include, but are not limited to, salts of the empirical general formula: ZrO(OH)_{2n-nz}B_{z}.wH₂0 in which z is a variable in the range of from 0.9 to 2.0 so that the value 2n-nz is zero or positive, n is the valency of B, and B is selected from the group consisting of chloride, other halide, sulfamate, sulfate and mixtures thereof. Possible hydration to a variable extent is represented by wH₂0. Preferable is that B represents chloride and the variable z lies in the range from 1.5 to 1.87. In practice, such zirconium salts are usually not employed by themselves, but as a component of a combined aluminum and zirconium-based antiperspirant.

Antiperspirant complexes based on the above-mentioned astringent aluminum and/or zirconium salts can be employed. The complex often employs a compound with a carboxylate group, and advantageously this is an amino acid. Examples of suitable amino acids include dl-tryptophan, dl-β-phenylalanine, dl-valine, dl-methionine and β-alanine, and preferably glycine which has the formula CH₂(NH₂)COOH.

It is desirable in at least one embodiment of the instant invention to employ complexes of a combination of aluminum halohydrates (especially chlorohydrates) and zirconium chlorohydrates together with amino acids such as glycine, which are disclosed in U.S. Pat. No. 3,792,068 (Luedders et al). Certain of those Al/Zr complexes are commonly called ZAG in the literature. ZAG actives include, but are not limited to, actives that contain aluminum, zirconium and chloride with an Al/Zr ratio in a range from 2 to 10, especially 2 to 6, an Al/Cl ratio from 2.1 to 0.9 and a variable amount of glycine.

Aluminium, zirconium and aluminium/zirconium salts are illustrative of some of the more common antiperspirant actives that may be used in the subject dispensers, but are no means exhaustive of the various antiperspirant actives that may be used in the subject formulations.

Antiperspirant actives are available from numerous suppliers, including, Summit, Reheis and Giulini.

The antiperspirant active may be present in amounts up to about 30 weight percent, and as noted above, may be absent when formulating other products. Antiperspirant compositions containing antiperspirant active in an amount of from 5 to 25 weight percent, more particularly from 5 to 20 weight percent, and in at least one embodiment of interest from 10 to 20 weight percent are of particular interest. Reference to active amounts is on an active basis and exclusive of carrier in which the actives may be supplied.

The volatile organic solvent provides a cooling sensation, aids in stabilizing the formulation, increases fragrance “lift”, and aids in wetting out the applicator head. As used herein the term “volatile” is used to designate a material having a measurable vapour pressure at ambient conditions. Desirably, the vapor pressure of the volatile organic solvent is sufficiently high to increase the drying rate of the composition into which it is incorporated. Of particular interest as volatile organic solvents are ethanol and isopropyl alcohol. In at least one embodiment it is preferred that ethanol and/or isopropyl alcohol comprise the major portion, by weight, of the volatile organic solvent, with other cosmetically acceptable volatile organic solvents, for example cyclopentasiloxene optionally, being present. In another embodiment, a cosmetically acceptable volatile organic solvent other than ethanol and/or isopropyl alcohol may comprise the major portion by weight of the volatile organic solvent.

The amount of volatile organic solvent depends, in part, on the product form of interest and the properties desired. In some embodiments, compositions containing volatile organic solvent in an amount of up to 85 weight percent or more, based on the total weight of the composition, are of interest, whereas, in other embodiments, compositions having 10 weight percent or less of volatile organic solvent are of interest. In some instances it may be desirable to eliminate volatile organic solvent entirely.

The cosmetic oils used herein are non-volatile, water miscible or immiscible liquids such as are normally used in cosmetic compositions. The cosmetic oils of choice are generally selected based on the particular product form of interest and the compatibility of the cosmetic oils with the other components present in the composition. In the case of antiperspirant compositions, for example, the carrier oil may be selected to aid in solubilizing the antiperspirant active. Carrier oils may also be selected for their emollient benefits. In the case of antiperspirant compositions, oils that also function as masking oils may also be of interest. In at least one embodiment, the preferred cosmetic oils are water miscible oils.

Included among the water miscible cosmetic oils of particular interest are for example, glycols such as for example, glycerine, and propylene glycol; polypropylene and polyethylene glycols, such as, for example, PPG-9, PPG-10, PPG-17, and PEG-8 to name a few. Exemplary of the water immiscible cosmetic oils are fatty alcohols, such as, for example, isostearyl alcohol. Ester oils, ether oils, hydrocarbon oils, are also among the cosmetic oils that may be used herein.

The amount of cosmetic oil present will depend upon the particular form of product of interest and the properties desired. In some embodiments compositions containing cosmetic oil in amounts up to 75 weight percent or more, based on the total weight of the composition are desired, whereas, in other embodiments the amount of cosmetic oil present may be as little as 1 weight or less, based on the total weight of the composition. In some instances it may be desirable to eliminate the cosmetic oil entirely. A description of cosmetic oils amounts in the context of a variety of different product forms is provided below, however, in many embodiments, particularly in the context of several of the emulsion forms of interest, compositions containing cosmetic oil in an amount of from 1 to 50 weight percent, more particularly, from 1 to 20 weight percent, even more particularly, from 1 to 10 weight percent are preferred.

Surfactants are another class of materials present in many of the compositions of interest. As many of the actives commonly used as antiperspirants are precipitated by anionic surfactants, the surfactants desirably employed many of the antiperspirant formulations employed in the subject formulations are desirably non-ionic or cationic. On their own, quaternary surfactants, may be insufficient to stabilize high ionic strength systems. Thus, the preferred surfactant in many embodiments is non-ionic surfactant alone or in combination with cationic surfactant. In at least one embodiment, the surfactants desirably have an HLB (hydrophilic lipohilic balance) value of greater than 9, preferably greater than 12. In at least one embodiment surfactants having HLB values greater than 15, preferably from 15 are of interest. In the case of non-ionic surfactants, HLB typically extend to 19, whereas, quaternary surfactants may have somewhat higher values, for example up to 25, or in some instances, even higher. The determination of HLB values is described, for example, in chapter 7 of HLB Systems, ICI Americas, Inc., (1984).

Included among the non-ionic surfactants suitable for use herein are PPG-5 ceteth-20, PEG-40 hydrogenated castor oil, isoceteth-20, steareth-100, PEG-24 glycereth-24, PEG/PPG-17/6 copolymer, polyoxyethylene/polyoxypropylene block copolymers and d-alpha-tocopheryl polyethylene glycol-1000 succinate. Included among the cationic surfactants that may be present are distearyl dimonium chloride and behenyl trimonium methosulfate. These are but a few, and by no means exhaustive of the numerous surfactants that may be used in the subject formulations.

The amount of surfactant present will depend upon the particular form of product of interest and the properties desired. In some embodiments, compositions containing surfactant in amounts up to 25 weight percent or more, based on the total weight of the composition are desired, whereas, in other embodiments, the amount of surfactant present may be as little as 1 weight percent or less, based on the total weight of the composition. A description of preferred amounts of surfactant in the context of a variety of different product forms is provided below, however, in many embodiments, particularly in the context of several of the emulsion forms of interest, compositions containing surfactant in an amount of from 1 to 25 weight percent, more particularly, from 1 to 15 weight percent, even more particularly, from 2 to 10 weight percent, are preferred.

Water, when present, is preferably deionized, demineralized or distilled. As with the other components listed the amount thereof present will depend, in part on the product form and properties desired. As referred to herein, anhydrous compositions typically contain no water, although water in an amount up to about 10 weight percent, based on the total weight of the composition, may be present. Preferably, the anhydrous compositions contain less than about 5 weight percent water, based on the total weight of the composition. When present in anhydrous compositions, water is commonly present as water of hydration or as a component of other raw materials.

The amount of water present will depend upon the particular form of product of interest and the properties desired. In some embodiments, compositions containing water in amounts up to 85 weight percent or more, based on the total weight of the composition are desired, whereas, in other embodiments, the amount of water present may be as little as 5 weight percent or less, based on the total weight of the composition. A description of preferred amounts of water in the context of a variety of different product forms is provided below, however, in many embodiments, particularly in the context of several of the emulsion forms of interest, compositions containing water in an amount of from 30 to 75 weight percent, more particularly, from 40 to 70 weight percent, even more particularly, from 40 to 60 weight percent are preferred.

Fragrance oil, when present is typically present in amounts up to about 5 weight percent, with amounts of from 0.5 to 3 weight percent being of particular interest in many embodiments.

Anhydrous solutions are one compositional form of interest herein. In one embodiment of interest the anhydrous solutions comprise from 5 to 30 weight percent of antiperspirant active, more particularly from 5 to 25 weight percent of antiperspirant active in a cosmetically acceptable vehicle capable of solubilizing the salt. Typically the cosmetically acceptable vehicle comprises one or more cosmetically acceptable volatile organic solvents. In one embodiment of interest the composition contains up to 85 weight percent of cosmetically acceptable volatile organic solvent, preferably comprising, as the major portion of such organic solvent, ethanol and/or isostearyl alcohol, with other cosmetically acceptable volatile organic solvents, for example, cyclopentasiloxane optionally being present. It is, however, also possible to formulate anhydrous compositions in which all or a portion of the volatile organic solvent is replaced by one or more polar solvents, non-limiting examples of which include, for example, propylene glycol, propylene carbonate, triacetin, triethyl citrate, and propylene glycol, with compositions wherein the polar solvent comprises propylene glycol being of particular interest. The polar solvents include some materials that are referred to above as carrier oils. Of particular interest in at least one embodiment are compositions that comprise from 5 to 20 weight percent antiperspirant salt, from 10 to 30 percent ethanol, 50 to about 75 percent of polar solvent, preferably comprising propylene glycol.

Cosolvent systems are other forms that the compositions used in the subject dispensers may take. Cosolvent systems are generally single phase compositions that comprise water, at least one volatile cosmetically acceptable water soluble or miscible organic co-solvent, preferably a relatively low molecular weight alcohol, such as, for example, ethanol and/or isopropyl alcohol, and minor amounts typically not exceeding 10 weight percent, more particularly, from about 1 to about 7 weight percent of lipophilic material such as fragrance oil and/or cosmetic oil. In at least one embodiment cosolvent systems containing from about 2 to about 5 weight percent of oil are of particular interest. In such compositions the water soluble or miscible organic co-solvent is incorporated in amounts of from about 40 to about 60 weight percent, more particularly from about 40 to about 55 weight percent The presence of water, in an amount of from about 20 to about 40 weight percent more particularly, from about 20 to about 35 weight percent, aids in solubilizing the antiperspirant active, while the presence of the cosolvent allows for the additional presence of up to about 7 percent of lipophilic material such as fragrance oil and cosmetic oil, while still retaining a single phase system.

A variation on the cosolvent system is a mixed solvent system in which the presence of surfactant allows the level of volatile organic solvent to be decreased, and the level of lipophilic material such as fragrance and/or cosmetic oil to be increased. In mixed solvent systems the surfactant is typically present in an amount from about 0.1 to about 5 percent, more preferably from about 0.5 to about 2%. Like solutions and cosolvent systems, mixed solvent systems are typically single phase compositions.

Multiple phase compositions, for example emulsions, represent other composition forms suitable for use herein. Such compositions typically comprise:
0-20 weight percent, more particularly, 2-10 weight percent cosmetic oil;
2-25 weight percent, more particularly 3-15 weight percent surfactant, the surfactant preferably comprising non-ionic surfactant;
0-40 weight percent, more particularly 2-20 weight percent volatile organic solvent, wherein from 50 to 100% by weight, preferably 75 to 100% by
   weight of the volatile organic solvent comprises ethanol and or/isopropyl alcohol;
5-30 weight percent, more particularly 10-20 weight percent antiperspirant active;
20-90 weight percent, more particularly, 20-80 weight percent water; and

optionally, fragrance oil in an amount up to about 5 weight percent, more particularly, 0.5-4 weight percent. In one embodiment, multiple phase compositions that contain water in an amount of 40 to 80 weight percent, more particularly 50 to 70 weight percent, are of interest. Compositions that contain 20 to 40 weight percent of water are other embodiments of multiple phase compositions of interest herein.

In a separate embodiment the subject invention relates to a dispenser comprising:
(a) an applicator head comprising a deformable, absorbent material, preferably covered with a fabric, mesh, sheet or sensory material; and
(b) a fluid having a surface tension of from 20 to 50 dynes/cm, more particularly, from 20 to 30 dynes/cm.
   In this separate embodiment, the applicator head and fluid components may optionally incorporate any of the deformable applicator head and fluid features previously described, and the dispenser may further comprise one or more of the dispenser components previously described, as additional optional components. For example, the dispenser desirably further comprises a cap.

The following non-limiting examples are provided to further illustrate compositions suitable for use in the subject dispensers. The invention is not limited thereto.

Antiperspirant compositions as provided in Tables 1 and 2 were prepared as anhydrous solutions. The anhydrous solutions were made by the following general procedure.

The antiperspirant active was dispersed in the polar solvent and heated with mixing to a temperature of ˜60° C. to dissolve the antiperspirant active. The resulting mixture was cooled to room temperature and the fragrance, volatile solvent and other ingredients were added.

Reported viscosities were measured using a Bohlen Controlled Stress Rheometer with a C25 cup and bob geometry at 25° C., using the controlled rate mode wherein incremental shear rate is applied. The viscosity is reported at a shear rate of 10 sec⁻¹.

TABLE 1

| | COMPOSITION | | | | | |
|---|---|---|---|---|---|---|
| COMPONENT (wt. %) | A1 | A2 | A3 | A4 | A5 | A6 |
| Fragrance | 1.2 | 1.2 | 1.2 | 1.2 | 1.2 | 1.2 |
| Cyclopentasiloxane | | 4.2 | | | | |
| PPG-9 | | 5.2 | | | | |
| SD Alcohol40 (190 proof) | 10 | 66.5 | 8.8 | 11.8 | | 15 |
| Propylene glycol | 20 | | 65 | 72 | 72 | 15 |
| PPG 10 | 20 | | | | | 20 |
| Propylene carbonate | 33.8 | | 10 | | 11.8 | 33.8 |
| Aluminum chlorohydrate | 15 | 22.9 | 15 | 15 | 15 | 15 |
| in Propylene glycol | | | | | | |
| (30 wt. % active) | | | | | | |
| TOTAL | 100 | 100 | 100 | 100 | 100 | 100 |

TABLE 2

| | COMPOSITION | | | | | | | |
|---|---|---|---|---|---|---|---|---|
| COMPONENT (wt. %) | B1 | B2 | B3 | B3 | B4 | B5 | B6 | B7 |
| Fragrance | 1.2 | 1.2 | 1.2 | 1.2 | 1.2 | | | |
| Ethanol | 10 | 10 | 10 | 15 | 15 | 15 | 15 | 10 |
| Propylene glycol | 67.5 | 60 | 52.5 | 63 | 56 | 49 | 44 | 49 |
| Propylene Carbonate | 7.5 | 15 | 22.5 | 7 | 14 | 21 | 21 | 26 |
| Triacetin | | | | | | | 5 | |
| PPG-10 | | | | | | | | |
| Aluminum chlorohydrate | 15 | 15 | 15 | 15 | 15 | 15 | 15 | 15 |
| in Propylene glycol | | | | | | | | |
| (30 wt. % active) | | | | | | | | |
| TOTAL | 100 | 100 | 100 | 100 | 100 | 100 | 100 | 100 |
| Viscosity (cps) | 24 | 16 | 14 | 19 | 14 | 11 | 11 | 12 |

Examples of cosolvent systems as described in Table 3 were prepared following the same general procedure as described for the preparation of anhydrous solutions, except that the active antiperspirant salt solution was used as received from the vendor, and all the components were added with mixing at room temperature.

TABLE 3

| | COMPOSITION | | | |
|---|---|---|---|---|
| COMPONENT (wt. %) | C1 | C2 | C3 | C4 |
| Fragrance | 1.2 | 1.16 | 1.5 | |
| PPG-14 butyl ether | | | 3 | |
| Isostearyl alcohol | 2.88 | | | |
| PPG-9 | | | | 4.4 |
| Aluminium Zirconium | 47.85 | 47.52 | 47.75 | 49.7 |
| Tetrachlorohydrex-Gly | | | | |
| (aqueous solution; | | | | |
| 45 wt. % active) | | | | |
| Ethanol | 47.85 | 47.52 | 47.75 | 49.7 |
| PPG-10 | | 3.8 | | |
| Total | 100 | 100 | 100 | 100 |

Tables 4 and 5 sets forth various microemulsions that were prepared by the following procedure:
1. A portion of the water was used to solubilize any solid surfactant.
2. The fragrance, surfactant liquids and cosmetic oils were mixed together to form a homogenous liquid, to which was added any surfactant solution, with mixing.
3. To the mixture of step 2 was added any remaining water, with mixing.
4. To the mixture of step 3 was added the salt solution with mixing.

5. Any additional water soluble ingredients are incorporated into the mixture of step 4 with mixing.

TABLE 4

| | COMPOSITION | | | | | | | | | |
|---|---|---|---|---|---|---|---|---|---|---|
| COMPONENT (Wt. %) | D1 | D2 | D3 | D4 | D5 | D6 | D7 | D8 | D9 | D10 |
| Fragrance oil | 1.5 | 1.5 | 1.5 | 1.5 | 1.5 | 1.5 | 1.5 | 1.5 | 1.5 | 1.5 |
| PPG-24-Glycereth-24 | 7.6 | 4 | 4 | 4 | 4 | 0 | 0 | 0 | 0 | 0 |
| PPG-5-Ceteth-20 | 7.5 | 6 | 6 | 6 | 6 | 6 | 6 | 6 | 6 | 6 |
| Polyether Polyol (HLB 15) | 7.8 | 8 | 4 | 2 | 0 | 0 | 0 | 0 | 0 | 0 |
| PEG/PPG-17/6 | | | | | | 8 | 8 | 8 | 8 | 7 |
| Copolymer | | | | | | | | | | |
| Aluminum Zirconium | 37.6 | 48 | 46 | 46 | 46 | 44.5 | 44.5 | 44.5 | 44.5 | 44.5 |
| Tetrachlorohydrex- | | | | | | | | | | |
| Glycine (aqueous | | | | | | | | | | |
| solution; 45% active) | | | | | | | | | | |
| Ethanol (95%) | | 5 | 5 | 5 | 5 | 4 | 3 | 2 | 1 | 5 |
| Delonized Water | 38 | 27.5 | 33.5 | 35.5 | 37.5 | 36 | 37 | 38 | 39 | 36 |
| Total | 100 | 100 | 100 | 100 | 100 | 100 | 100 | 100 | 100 | 100 |

COMPOSITION

| COMPONENT (Wt. %) | D11 | D12 | D13 | D14 | D15 | D16 | D17 | D18 | D19 |
|---|---|---|---|---|---|---|---|---|---|
| Fragrance oil | 1.5 | 1.5 | 1.5 | 1.5 | 1.5 | 1.5 | 1.5 | 1.5 | 1.5 |
| PPG-24-Glycereth-24 | 0 | 0 | 0 | 0 | 4 | 4 | 4 | 4 | 4 |
| PPG-5-Ceteth-20 | 6 | 6 | 6 | 6 | 6 | 6 | 6 | 6 | 6 |
| Polyether Polyol (HLB 15) | 0 | 0 | 0 | 0 | 0 | 0 | 0 | 0 | 0 |
| PEG/PPG-17/6 | 6 | 5 | 4 | 3 | | | | | |
| Copolymer | | | | | | | | | |
| Aluminum Zirconium | 44.5 | 44.5 | 44.5 | 44.5 | 44.5 | 44 | 43 | 42 | 40 |
| Tetrachlorohydrex- | | | | | | | | | |
| Glycine (aqueous | | | | | | | | | |
| solution; 45% active) | | | | | | | | | |
| Ethanol (95%) | 5 | 5 | 5 | 5 | 5 | 5 | 5 | 5 | 5 |
| Delonized Water | 37 | 38 | 39 | 40 | 39 | 39.5 | 40.5 | 41.5 | 43.5 |
| Total | 100 | 100 | 100 | 100 | 100 | 100 | 100 | 100 | 100 |

TABLE 5
COMPOSITIONS

| COMPONENT (Wt. %) | E1 | E2 | E3 | E4 | E5 | E6 | E7 | E8 | E9 | E10 |
|---|---|---|---|---|---|---|---|---|---|---|
| Fragrance oil | 1.5 | 1.5 | 1.5 | 1.5 | 1.5 | 1.5 | 1.5 | 1.5 | 1.0 | 1.5 |
| Ethanol | 5.0 | 5.0 | 12.0 | 5.0 | 5.0 | 5.0 | 10.0 | 10.0 | | |
| Isostearyl alcohol | | | | | | | | | | 0.5 |
| Ethyl Perfluorobutyl ether | 1.0 | | | | | | | | | |
| Glycerin | | | | | | | | | | |
| PEG-8 | | | | | | | | | | |
| PPG-9 | | | | 1.1 | | | | | | |
| PPG-10 | | | | | | | | | | |
| PEG-180 | | | | | | | | | | 2.0 |
| PEG-40 hydrogenated | 2.0 | 2.0 | | 2.0 | 2.0 | 2.0 | | | 2.0 | |
| castor oil | | | | | | | | | | |
| PEG-60 hydrogenated | | | | | | | 6.0 | 2.0 | | |
| castor oil | | | | | | | | | | |
| Aluminum Zirconium | 53.0 | 52.0 | 41.0 | 52.0 | 52.0 | 52.0 | 52.0 | 52.0 | 55.0 | 53.0 |
| Tetrachlorohydrex-Glycine | | | | | | | | | | |
| (aqueous solution 45 wt. % | | | | | | | | | | |
| active) | | | | | | | | | | |
| Isoceteth-20 | 2.0 | | 3.0 | | | | | | | |
| Glycereth-31 | | | | | | | | | | |
| PPG -5-ceteth-20 | 4.0 | 3.0 | 4.0 | 3.0 | 3.0 | 4.0 | | 4.0 | | 4.5 |
| PEG 100 stearyl ether | 1.5 | 1.0 | | | | | | | 2.0 | 3.0 |
| PEG-24-glycereth-24 | | 4.0 | | 3.0 | 3.0 | 3.0 | | | | |
| Disodium EDTA | | | | | | | | | | |
| Deionized Water | 30.0 | 31.5 | 38.5 | 32.4 | 33.5 | 32.5 | 30.5 | 30.5 | 40.0 | 35.5 |
| Total | 100 | 100 | 100 | 100 | 100 | 100 | 100 | 100 | 100 | 100 |

| COMPONENT (Wt. %) | E11 | E12 | E13 | F1 | F2 | F3 | F4 | F5 | G1 |
|---|---|---|---|---|---|---|---|---|---|
| Fragrance oil | 1.5 | 1.5 | 1.5 | 1.2 | 1.2 | 1.2 | 1.2 | 1.2 | 1.8 |
| Ethanol | | | | 10.0 | 20.0 | 10.0 | 20.0 | 8.0 | 4.5 |
| Isostearyl alcohol | | | | | | | | | |
| Ethyl Perfluorobutyl ether | | | | | | | | | |
| Glycerin | | | | 2.0 | | | | | 2.0 |
| PEG-8 | | | | | | | | | 3.0 |
| PPG-9 | | | | | | | | 1.5 | |
| PPG-10 | | | | 2.4 | 3.3 | 3.3 | 4.2 | | |
| PEG-180 | | | | | | | | | |
| PEG-40 hydrogenated | 4.0 | 2.0 | 2.0 | | | | | | |
| castor oil | | | | | | | | | |
| PEG-60 hydrogenated | | | | | | | | | 6.0 |
| castor oil | | | | | | | | | |
| Aluminum Zirconium | 55.0 | 55.0 | 53.0 | 40.0 | 40.0 | 40.0 | 40.0 | 48 | 40.0 |
| Tetrachlorohydrex-Glycine | | | | | | | | | |
| (aqueous solution 45 wt. % | | | | | | | | | |
| active) | | | | | | | | | |
| Isoceteth-20 | | | | | | | | | |
| Glycereth-31 | | | 1.0 | | | | | | |
| PPG -5-ceteth-20 | | 2.0 | 2.0 | 5.0 | 6.0 | 6.0 | 6.0 | 5.5 | |
| PEG 100 stearyl ether | 4.0 | 4.0 | 4.0 | | | | | | |
| PEG-24-glycereth-24 | | | | | | | | 1.5 | 2.0 |
| Disodium EDTA | | | | | | | | | 0.1 |
| Deionized Water | 35.5 | 35.5 | 36.5 | 39.4 | 27.5 | 39.5 | 34.3 | 34.3 | 40.6 |
| Total | 100 | 100 | 100 | 100 | 100 | 100 | 100 | 100 | 100 |

Phase inversion temperature emulsions as described in Table 6 were prepared by the following procedure:
1. The oil phase components and surfactants were added to the water phase components with mixing, and heated until clear.
2. Heating of the mixture of step 2 was continued until its appearance became cloudy.

3. When cloudy, the mixture was rapidly cooled with rapid mixing.

TABLE 6

| | Composition | | |
|---|---|---|---|
| COMPONENT (wt. %) | H1 | H2 | H3 |
| Fragrance | 1.02 | 1.04 | 1.25 |
| Hydrogenated polydecene | 2.56 | 4.86 | 5.83 |
| Cyclopentasiloxane | 2.05 | 4.17 | 5 |
| Petrolatum | 0.82 | | |
| Ethoxynonafluorobutane | 3.3 | | |
| PEG-4 Lauryl ether (Laureth-4) | 4.33 | 4.51 | 5.41 |
| Isoceteth- 20 | 4.03 | 4.19 | 5.03 |
| Aluminum Zirconium Tetrachlorohydrex-Gly | 53.24 | | 66.65 |
| (aqueous solution; 45% active) | | | |
| Aluminum Zirconium Pentachlorohydrate | | 55.54 | |
| (aqueous solution; 45% active) | | | |
| Water | 28.65 | 25.69 | 10.83 |
| Total | 100 | 100 | 100 |

Following the general procedure described above for the preparation of the Table 1 compositions, an anhydrous deodorant composition containing the following components was prepared; 30.0 weight percent PPG-14 butyl ether; 66.5 weight percent cyclopentasiloxane; 1.5 weight percent fragrance oil; and 3.0 weight percent ethanol (190 proof).

It is noted that anhydrous cosolvent, emulsion and microemulsion deodorant compositions can be formulated by removing the antiperspirant salt from the composition described in Tables 1 to 5 and adjusting the carrier to makeup for the antiperspirant active removed.

What is claimed is:

1. A fluid dispenser comprising:
a) a fluid reservoir,
b) a fluid feed line,
c) a fluid transfer zone,
d) a capillary overflow,
e) a capillary control valve, and
f) a porous applicator head, wherein:
i) the fluid feed line communicates with the fluid reservoir and the fluid transfer zone;
ii) the fluid transfer zone is intermediate to the porous applicator head and capillary overflow;
iii) the capillary overflow is in communication with the transfer zone and/or the fluid feed line; and
iv) fluid is drawn through the porous applicator head by means of capillary action; and
v) the capillary control valve regulates the flow of fluid in and out of the capillary overflow.

2. A dispenser according to claim 1, wherein the capillary control valve comprises a capillary material.

3. A dispenser according to claim 2 wherein the capillary control valve comprises a 3-dimensional open pore network structure.

4. A dispenser according to claim 1 wherein the transfer zone provides a free flow of fluid to the lower surface of the applicator head.

5. A dispenser according to claim 1 wherein the transfer zone further comprises a gross capillary.

6. A dispenser according to claim 5, wherein the gross capillary has sufficient capillarity to hold fluid at the back surface of the applicator head.

7. A dispenser according to claim 1 wherein the transfer zone further comprises a plurality of capillary ports.

8. A dispenser according to claim 1 wherein the fluid to be dispensed is a deodorant.

9. A dispenser according to claim 1 wherein the fluid to be dispensed is an antiperspirant.

10. A dispenser according to claim 1 wherein the fluid to be dispensed has a room temperature viscosity of less than 100 centipoise.

11. A dispenser according to claim 1 wherein the applicator head comprises a sintered porous plastic.

12. A dispenser according to claim 1 wherein the applicator head comprises a deformable porous material.

13. A dispenser according to claim 12 wherein the deformable porous material is covered with a fabric, sheet or mesh.

14. A product according to claim 1, wherein the outer surface of the applicator head is domed.

15. A product according to claim 1 wherein the product to be dispensed has a surface tension of 20 to 50 dynes/cm.

16. A method of dispensing a fluid onto a surface which comprises bringing the applicator head of the dispenser of claim 1 into contact with, and moving it across such surface.

17. A capillary dispenser for dispensing fluid, said dispenser comprising a capillary dispensing means, a porous capillary applicator head, and a cap, wherein, when the cap is locked in position on the dispenser, there is a capillary gap between the top surface of the applicator head and the bottom of the cap, sufficient to reabsorb fluid from the cap, back into the applicator head.

18. A fluid dispenser comprising:
a) a fluid reservoir,
b) a fluid feed line,
c) a fluid transfer zone comprising a gross capillary,
d) a porous applicator head, wherein:
i) the fluid feed line communicates with the fluid reservoir and the fluid transfer zone;
ii) the fluid transfer zone is intermediate to the porous applicator head and the fluid reservoir; and
iii) fluid is drawn through the porous applicator head by means of capillary action.

19. A method as described in claim 16 wherein the surface is impermeable to the fluid to be dispensed.

20. A fluid dispenser comprising:
a) a fluid reservoir,
b) a fluid feed line,
c) a fluid transfer zone,
d) a capillary overflow,
e) a capillary control valve that regulates the flow of fluid in and out of the capillary overflow, and
f) a porous applicator head, wherein:
i) the fluid feed line communicates with the fluid reservoir and the fluid transfer zone;
ii) the fluid transfer zone is intermediate to the porous applicator head and capillary overflow;
iii) the capillary overflow is in communication with the transfer zone via the capillary control valve; and
iv) fluid is drawn through the porous applicator head by means of capillary action.

21. A dispenser as described in claim 1 that further comprises, as the fluid to be dispensed, a cosmetic or personal care product.

22. A dispenser as described in claim 1 that further comprises as the fluid to be dispensed, a cosmetic or personal care product having a viscosity of 5 to 30 cps.

23. A dispenser as described in claim 22 wherein the fluid to be dispensed has a viscosity of from 8 to 15 cps.

24. A dispenser as described in claim 1 that further comprises, as the fluid to be dispensed, a cosmetic or personal care composition having a surface tension of from 20 to 50 dynes/cm.

25. A dispenser as described in claim 24 wherein the fluid to be dispensed has a surface tension of from 20 to 35 dynes/cm.
